(19) United States
(12) Patent Application Publication
(10) Pub. No.: US 2019/0087261 A1
(43) Pub. Date: Mar. 21, 2019

(54) ERROR DETECTION CIRCUIT APPLIED TO DIGITAL COMMUNICATION SYSTEM WITH EMBEDDED CLOCK

(71) Applicant: Raydium Semiconductor Corporation, Hsinchu (TW)

(72) Inventors: CHIH-CHUAN HUANG, Zhubei City (TW); SUNG-BO CHEN, Zhubei City (TW); YUE-TING WU, Taipei City (TW)

(21) Appl. No.: 16/137,658

(22) Filed: Sep. 21, 2018

Related U.S. Application Data
(60) Provisional application No. 62/561,221, filed on Sep. 21, 2017.

(51) Int. Cl. G06F 11/07; H04L 7/00

(52) U.S. Cl. CPC G06F 11/0757; G06F 11/0772; H04L 7/0054

(57) ABSTRACT

An error detection circuit, applied to a digital communication system with embedded clock, includes a time delay unit, a clock embedding encoding unit, a comparing unit and a packet error counting unit. The time delay unit delays a first digital encoded signal for a period of time. The clock embedding encoding unit generates a second digital encoded signal according to a first digital decoded signal, wherein the first digital decoded signal is generated by decoding the first digital encoded signal. The comparing unit is coupled to the time delay unit and the clock embedding encoding unit respectively and compares the first digital encoded signal with the second digital encoded signal to generate a compared result. The packet error counting unit is coupled to the comparing unit and counts a packet error rate according to the compared result and then provides a flag according to the packet error rate.

### BACKGROUND OF THE INVENTION

### 1. Field of the Invention

The invention relates to error detection; in particular, to an error detection circuit applied to a digital communication system with embedded clock.

### 2. Description of the Prior Art

Referring to FIG. 1, in the conventional digital communication system, the transmitter TX can transmit data to the receiver RX through the data transmission channel CH. The transmitter TX can include N units T₁˜T_{N} and the order is T₁, T₂, . . . , T_{N-1}, T_{N}, wherein N is a positive integer; the receiver RX may include N units R₁˜R_{N} and the order is R_{N}, R_{N-1}, . . . , R₂, R₁. That is to say, the N units T₁˜T_{N} of the transmitter TX correspond to the N units R₁˜R_{N} of the receiver RX respectively, but the arrangement order and operation of the N units T₁˜T_{N} of the transmitter TX and the N units R₁˜R_{N} of the receiver RX are opposite to each other.

When considering error detection in a digital communication system with an embedded clock, the transmitter TX and the receiver RX are usually provided with some coding units and decoding units.

For example, as shown in FIG. 2, the transmitter TX can include an error detection encoding unit EDE and a clock-embedding encoding unit CEE, and the receiver RX can include a clock recovery decoding unit CRD and an error detection decoding unit EDD, wherein the error detection encoding unit EDE of the transmitter TX and the error detection decoding unit EDD of the receiver RX are used for error detection, and the clock embedding encoding unit CEE and the clock recovery decoding unit CRD of the transmitter TX are used for the clock embedding and recovery.

It is assumed that the number of overhead data bits of the digital data signal inputted to the error detection encoding unit EDE is n, after being encoded by the error detection encoding unit EDE the number of overhead data bits will become (n+m), and then after being encoded by the clock embedding encoding unit CEE, the number of overhead data bit will become (n+m+p). And then, it is transmitted to the receiver RX via the data transmission channel CH, after being decoded by the clock recovery decoding unit CRD, the number of overhead data bit will become (n+m), and after being decoded by the error detection decoding unit EDD, the number of overhead data bit will become n, wherein n, m, p are all positive integers.

The disadvantage of this method is that the excessive number of overhead data bits of the digital data signal will cause the bandwidth of the data transmission channel CH to be wasted and the error detection encoding unit EDE and error detection decoding unit EDD are necessary to be additionally disposed in the transmitter TX and the receiver RX respectively. And, some error detection mechanisms cannot be performed immediately, resulting in poor debugging efficiency.

In addition, as shown in FIG. 3, it is assumed that the transmitter TX and the receiver RX omit the setting of the error detection encoding unit EDE and the error detection decoding unit EDD respectively, so that the number of overhead data bit of the digital data signal transmitted by the data transmission channel CH can be reduced from (n+m+p) in FIG. 2 to (n+p) in FIG. 3, but the receiver RX still needs to additionally include the codeword checking unit CWC to detect the error of the digital data signal, which may result in its error detect ability is reduced. For example, as shown in FIG. 4, assuming that n=8 and p=1, the number of overhead data bits of the unencoded digital data signal D is 8 (e.g., including the overhead data bits b7˜b0), and the number of overhead data bits of the encoded digital data signal E encoded by the clock embedding encoding unit CEE is 9 (e.g., including the overhead data bit b8˜b0, and at least one transfer TRAN exists between the overhead data bits b2 and b1 and between the overhead data bits b1 and b0. When the receiver RX receives the digital data signal E, the codeword checking unit CWC will determine whether the digital data signal E received is correct, but its error detection rate is not good, only about (2/8)/(256/512)=0.5, which needs to be improved.

### SUMMARY OF THE INVENTION

Therefore, the invention provides an error detection circuit applied to a digital communication system with embedded clock to solve the above-mentioned problems of the prior arts.

A preferred embodiment of the invention is an error detection circuit. In this embodiment, the error detection circuit is applied to a digital communication system with embedded clock. The error detection circuit includes a time delay unit, a clock embedding encoding unit, a comparing unit and a packet error counting unit. The time delay unit is configured to delay a first digital encoded signal for a period of time. The clock embedding encoding unit is configured to generate a second digital encoded signal according to a first digital decoded signal, wherein the first digital decoded signal is generated by decoding the first digital encoded signal. The comparing unit is coupled to the time delay unit and the clock embedding encoding unit respectively and configured to compare the first digital encoded signal with the second digital encoded signal to generate a compared result. The packet error counting unit is coupled to the comparing unit and configured to count a packet error rate according to the compared result and then provides a flag according to the packet error rate.

In an embodiment, the error detection circuit is disposed in a receiver.

In an embodiment, the receiver includes a clock recovery decoding unit coupled to the time delay unit and the clock embedding encoding unit respectively and configured to decode the first digital encoded signal to generate the first digital decoded signal.

In an embodiment, the receiver receives the first digital encoded signal from a data transmission channel.

In an embodiment, the first digital encoded signal is transmitted to the data transmission channel by a transmitter.

In an embodiment, the transmitter includes another clock embedding encoding unit configured to generate the first digital encoded signal.

In an embodiment, the another clock embedding encoding unit encodes a digital signal to generate the first digital encoded signal.

In an embodiment, the another clock embedding encoding unit is equivalent to the clock embedding encoding unit.

In an embodiment, the flag provided by the packet error counting unit is used to adjust a design parameter of the receiver.

In an embodiment, the flag provided by the packet error counting unit is used to adjust a design parameter of the transmitter.

In an embodiment, the packet error counting unit compares the packet error rate with an error tolerance threshold to determine whether to provide the flag.

In an embodiment, the error tolerance threshold is adjustable.

In an embodiment, the packet error counting unit is resettable.

Compared to the prior art, the error detection circuit of the invention can be applied to a digital communication system with an embedded clock and achieve the highest error detection rate without the error detection encoding unit and the error detection decoding unit disposed in the transmitter and the receiver respectively and without the codeword checking unit in the receiver. In addition, the packet error counting unit in the error detection circuit of the invention is resettable and the error tolerance threshold used in the error detection circuit is adjustable, and the flag provided by the packet error counting unit can be used to adjust design parameters of the transmitter and the receiver to ensure the robustness of the connection between the transmitter and the receiver.

The advantage and spirit of the invention may be understood by the following detailed descriptions together with the appended drawings.

### BRIEF DESCRIPTION OF THE APPENDED DRAWINGS

FIG. 1 illustrates a schematic diagram of the transmitter and the receiver including corresponding units respectively in the prior art.

FIG. 2 illustrates a schematic diagram of the error detection encoding unit and error detection decoding unit necessarily disposed in the transmitter and the receiver respectively in the prior art.

FIG. 3 illustrates a schematic diagram of the codeword checking unit necessarily disposed in the receiver in the prior art.

FIG. 4 illustrates the variation of the overhead data bits between the unencoded digital data signal and encoded digital data signal in the prior art.

FIG. 5 illustrates a schematic diagram of the error detection circuit applied to the receiver in an embodiment of the invention.

FIG. 6 illustrates a schematic diagram of the mechanism of increasing the error detection rate.

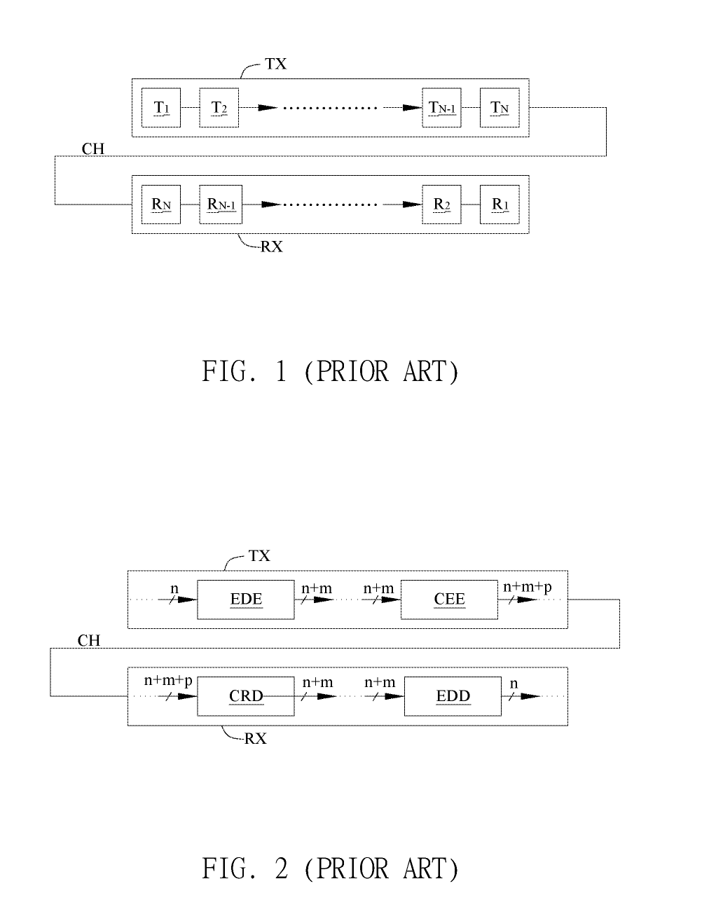

### DETAILED DESCRIPTION OF THE INVENTION

A preferred embodiment of the invention is an error detection circuit. In this embodiment, the error detection circuit can be applied to a digital communication system with an embedded clock; for example, it can be applied to the high-speed serial transmission interface for video data transmission, but not limited to this.

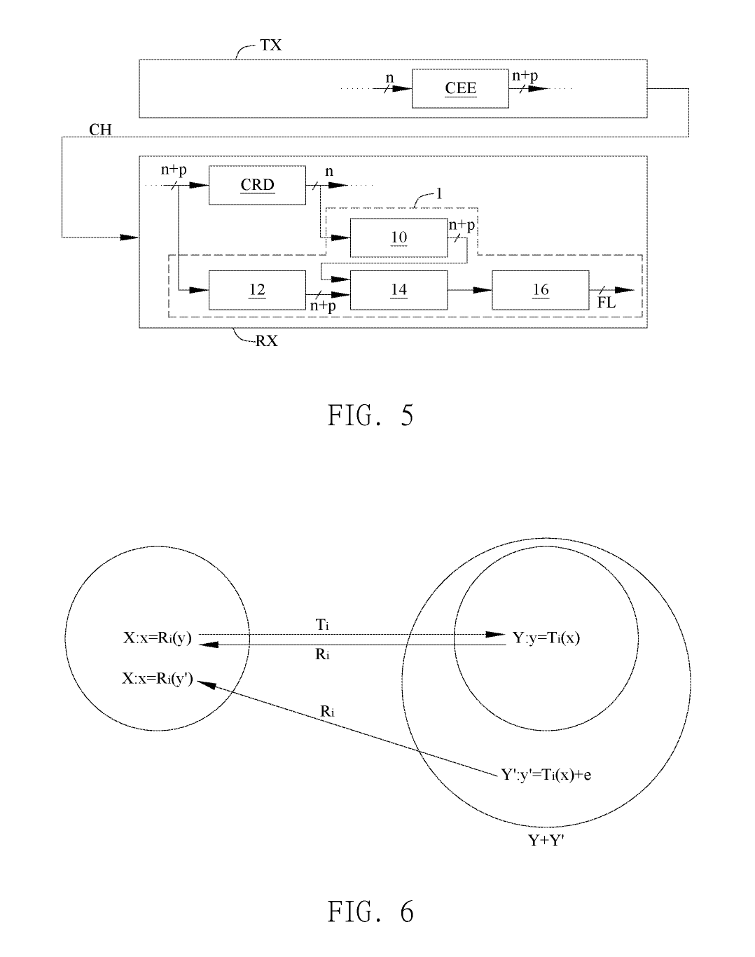

Please refer to FIG. 5. FIG. 5 illustrates a schematic diagram of the error detection circuit 1 applied to the receiver RX in this embodiment.

As shown in FIG. 5, it is assumed that the digital communication system with embedded clock includes a transmitter TX, a receiver RX and a data transmission channel CH. The transmitter TX and the receiver RX transmit data through the data transmission channel CH. The error detection circuit 1 is disposed in the receiver RX.

The transmitter TX includes a clock embedding encoding unit CEE for performing clock encoding on the digital data signal to generate a first digital encoded signal. It is assumed that the number of overhead data bits of the digital data signal inputted to the clock embedding coding unit CEE is n, and after the digital data signal is encoded by the clock embedding encoding unit CEE, the number of overhead data bits of the first digital encoded signal will become (n+p). Then, the transmitter TX transmits the first digital encoded signal to the receiver RX through the data transmission channel CH.

The receiver RX includes a clock recovery decoding unit CRD and an error detection circuit 1. The clock recovery decoding unit CRD is coupled to the data transmission channel CH. The error detection circuit 1 is respectively coupled to the input terminal and the output terminal of the clock recovery decoding unit CRD. The clock recovery decoding unit CRD is configured to receive the first digital encoded signal transmitted by the data transmission channel CH and perform clock recovery decoding on the first digital encoded signal to generate a first digital decoded signal. The number of overhead data bits of the first digital encoded signal inputted to the clock recovery decoding unit CRD is (n+p), and after the clock recovery decoding unit CRD performs the clock recovery decoding, the number of overhead data bits of the first digital decoding signal is n.

In this embodiment, the error detection circuit 1 includes a clock embedding encoding unit 10, a time delay unit 12, a comparison unit 14, and a packet error counting unit 16. The clock embedding encoding unit 10 is coupled to the output terminal of the clock recovery decoding unit CRD; the time delay unit 12 is coupled to the input terminal of the clock recovery decoding unit CRD; and the comparison unit 14 is coupled to the time delay unit 12 and the output terminal of the clock embedding coding unit 10 respectively; the packet error counting unit 16 is coupled to the output terminal of the comparing unit 14.

The clock embedding coding unit 10 is configured to receive the first digital decoding signal outputted by the clock recovery decoding unit CRD and perform clock-embedded encoding on the first digital decoding signal to generate a second digital encoded signal and then output the second digital encoded signal to the comparison unit 14. The number of overhead data bits of the first digital decoding signal outputted by the clock recovery decoding unit CRD is n, and after the clock embedding coding unit 10 performs the clock embedding coding, the number of overhead data bits of the second digital encoded signal will become (n+p).

In practical applications, the clock embedding encoding unit 10 in the error detection circuit 1 of the receiver RX can be the same as the clock embedding encoding unit CEE in the transmitter TX, but is not limited thereto. The common receiver RX is often built with the clock embedding encoding unit 10 for built-in self-test, especially in applications such as high-speed serial transmission interfaces for video data transmission.

The time delay unit 12 is configured to receive the first digital encoded signal transmitted by the data transmission channel CH from the input terminal of the clock recovery decoding unit CRD and delay the first digital encoded signal for a period of time and then output it to the comparison unit 14. Since the time delay unit 12 does not encode or decode the first digital encoded signal, it is believed that the number of overhead data bits of the first digital encoded signal will be still (n+p).

The comparing unit 14 receives the first digital encoded signal outputted by the time delay unit 12 and the second digital encoded signal outputted by the clock embedding encoding unit 10 and compares the first digital encoded signal with the second digital encoded signal to generate a comparison result. The number of overhead data bits of the first digital encoded signal and the second digital encoded signal are both (n+p). It should be noted that when the comparing unit 14 compares the first digital encoded signal and the second digital encoded signal, the comparing unit 14 will compare each bit in the packet of the first digital encoded signal and the second digital encoded signal to ensure that all error packets can be detected.

Next, the packet error counting unit 16 will count the packet error rate according to the comparison result obtained by comparing the first digital encoded signal with the second digital encoded signal by the comparing unit 14 and provide the flag FL according to the packet error rate.

In practical applications, the packet error counting unit 16 can compare the counted packet error rate and an error tolerance threshold to determine whether to provide the flag FL. For example, when the packet error counting unit 16 finds that the counted packet error rate is greater than the error tolerance threshold, the packet error counting unit 16 will provide the flag FL.

It should be noted that the packet here refers to the second digit encoded signal having (n+p) overhead data bits, and the packet error means that at least one bit in the packet has an error. The error tolerance threshold is an adjustable count target value.

In addition, the packet error counting unit 16 can be reset in a programming way. For example, in the video applications, the line reset way or frame reset way can be used to reset the packet error counting unit 16, such that the change of the flag FL occurs in the horizontal blanking or vertical blanking to reduce the impact on the video image.

In an embodiment, the flag provided by the packet error counting unit 16 can be used to adjust the design parameters of the receiver RX and the transmitter TX to ensure the stability of the connection between the transmitter TX and the receiver RX.

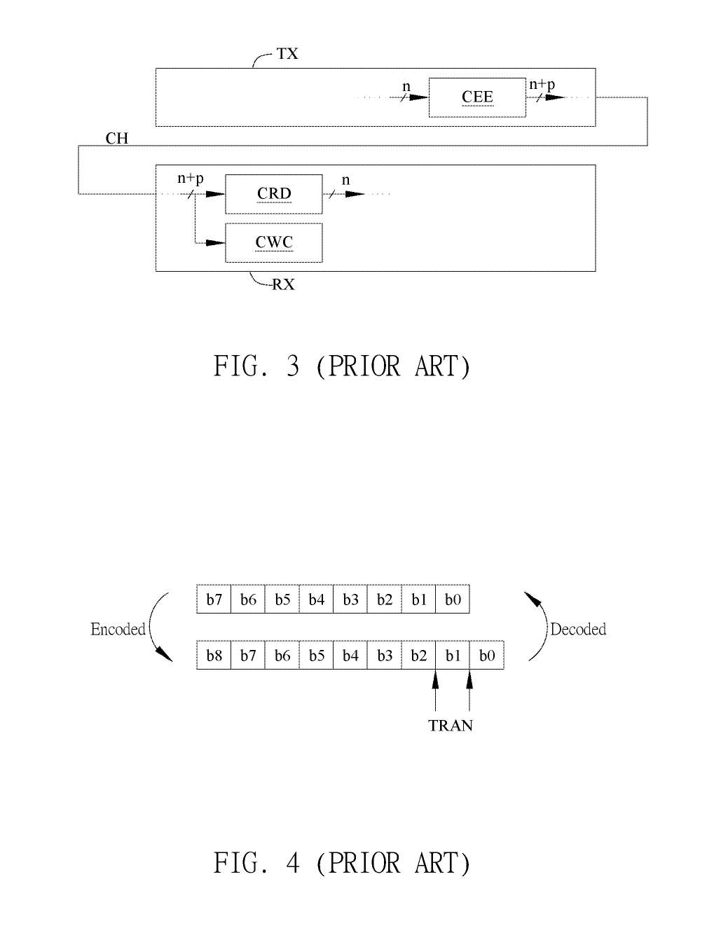

Please refer to FIG. 6. Ti and Ri represent a function pair located at the transmitter TX and the receiver RX respectively, which introduces the overhead data of the encoding/decoding of the clock embedding/clock recovery in FIG. 2 and FIG. 3. Therefore, for the sake of simplicity, assuming that the perfect data transmission channel CH has no noise, then the clock embedding encoding is to map Ti from element x to element y, where x is an element in the set X formed by n-bits binary codes, and y is an element in the subset Y of the complete set (Y+Y′) formed by (n+p) bits binary codes. The clock recovery decoding is to map Ri from the element y (the input of the clock recovery decoding) to the element x. In addition, if the noise of the data transmission channel CH is considered, at the receiver end, the input of the clock recovery decoding will be (Ti(x)+e), wherein e represents the error caused by the noise in the data transmission channel CH, and (Ti(x)+e) may fall into the subset Y′ of the full set (Y+Y′). It should be noted that the corresponding decoded data is still the element x, since mapping Ri from the full set (Y+Y′) to the element x is actually a many-to-one mapping.

The above analysis means that the following criterion (I) and its equivalent criterion (II) can be applied to error detection:

(I) If the input of Ri does not belong to the subset Y, for example, the input of Ri belongs to the subset Y′, then at least one bit has an error.

(II) If the input of Ri is not equal to Ti (Ri (input of Ri)), at least one bit has an error.

Referring to FIG. 6, the conditional probability P obtained by dividing the error detected based on the above criterion (II) by the error code falling in the subset Y′ is obviously 1, so that when there is no encoding/decoding dedicated for error detection, the upper limit of the error detection rate can be obtained directly based on the criterion (II). In order to explain this more quantitatively, if the example in FIG. 4 is examined according to the criterion (II), the conditional probability P obtained by dividing the error detected based on the above criterion (II) by the error code falling in the subset Y′ will be [(256/512)*(256/256)]/(256/512)=1.

Compared to the prior art, the error detection circuit of the invention can be applied to a digital communication system with an embedded clock and achieve the highest error detection rate without the error detection encoding unit and the error detection decoding unit disposed in the transmitter and the receiver respectively and without the codeword checking unit in the receiver. In addition, the packet error counting unit in the error detection circuit of the invention is resettable and the error tolerance threshold used in the error detection circuit is adjustable, and the flag provided by the packet error counting unit can be used to adjust design parameters of the transmitter and the receiver to ensure the robustness of the connection between the transmitter and the receiver.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An error detection circuit, applied to a digital communication system with embedded clock, the error detection circuit comprising:
a time delay unit, configured to delay a first digital encoded signal for a period of time;
a clock embedding encoding unit, configured to generate a second digital encoded signal according to a first digital decoded signal, wherein the first digital decoded signal is generated by decoding the first digital encoded signal;
a comparing unit, coupled to the time delay unit and the clock embedding encoding unit respectively and configured to compare the first digital encoded signal with the second digital encoded signal to generate a compared result; and
a packet error counting unit, coupled to the comparing unit and configured to count a packet error rate according to the compared result and then provide a flag according to the packet error rate.

2. The error detection circuit of claim 1, wherein the error detection circuit is disposed in a receiver.

3. The error detection circuit of claim 2, wherein the receiver comprises a clock recovery decoding unit coupled to the time delay unit and the clock embedding encoding unit respectively and configured to decode the first digital encoded signal to generate the first digital decoded signal.

4. The error detection circuit of claim 2, wherein the receiver receives the first digital encoded signal from a data transmission channel.

5. The error detection circuit of claim 4, wherein the first digital encoded signal is transmitted to the data transmission channel by a transmitter.

6. The error detection circuit of claim 5, wherein the transmitter comprises another clock embedding encoding unit configured to generate the first digital encoded signal.

7. The error detection circuit of claim 6, wherein the another clock embedding encoding unit encodes a digital signal to generate the first digital encoded signal.

8. The error detection circuit of claim 6, wherein the another clock embedding encoding unit is equivalent to the clock embedding encoding unit.

9. The error detection circuit of claim 2, wherein the flag provided by the packet error counting unit is used to adjust a design parameter of the receiver.

10. The error detection circuit of claim 5, wherein the flag provided by the packet error counting unit is used to adjust a design parameter of the transmitter.

11. The error detection circuit of claim 1, wherein the packet error counting unit compares the packet error rate with an error tolerance threshold to determine whether to provide the flag.

12. The error detection circuit of claim 11, wherein the error tolerance threshold is adjustable.

13. The error detection circuit of claim 1, wherein the packet error counting unit is resettable.
